(19) United States
(12) Patent Application Publication
(10) Pub. No.: US 2026/0055847 A1
(43) Pub. Date: Feb. 26, 2026

(54) PRESSURE VESSEL ASSEMBLY

(71) Applicants: Hyundai Motor Company, Seoul (KR); Kia Corporation, Seoul (KR)

(72) Inventor: Chan Jin KIM, Hwaseong-Si (KR)

(21) Appl. No.: 19/209,430

(22) Filed: May 15, 2025

(30) Foreign Application Priority Data
Aug. 26, 2024 (KR) 10-2024-0114623

(51) Int. Cl. F17C 1/06

(52) U.S. Cl. CPC F17C 1/06; F17C 2201/0104; F17C 2203/0609

(57) ABSTRACT

An embodiment of the present disclosure relates to a pressure vessel assembly. The pressure vessel assembly may include a pressure vessel comprising a cylinder, and domes provided at two opposite ends of the cylinder; a protector configured to surround an outer surface of the domes; and a restraint band configured to surround the protector and the pressure vessel, restrain the protector to the pressure vessel, and define exposure regions through which the protector and the pressure vessel are partially exposed.

### CROSS-REFERENCE TO RELATED APPLICATION

This application claims priority to and the benefit of Korean Patent Application No. 10-2024-0114623, filed in the Korean Intellectual Property Office on Aug. 26, 2024, the entire contents of which are incorporated herein by reference.

### TECHNICAL FIELD

The present disclosure relates to vehicle fuel storage, and more particularly, to a pressure vessel assembly of a vehicle.

### BACKGROUND

A hydrogen electric vehicle (e.g., a passenger vehicle or a commercial vehicle) may generate electricity by means of a chemical reaction between hydrogen and oxygen, and travel by operating a motor. For example, a hydrogen electric vehicle may include a hydrogen storage system, such as a pressure vessel for storing hydrogen (H₂) gas.

The pressure vessel may be, for example, a TYPE 4 pressure vessel. The TYPE 4 pressure vessel may include a liner (e.g., made of a nonmetallic material), and a carbon fiber layer made by winding a carbon fiber composite material around an outer surface of the liner.

However, in some implementations of the pressure vessel that have a structure where two opposite dome parts of the pressure vessel each have a dome shape, it may be difficult to wind a carbon fiber composite material, with a sufficient thickness, around the dome parts of the pressure vessel. For this reason, it may be difficult to ensure sufficient structural rigidity at the dome parts of the pressure vessel.

In particular, the pressure vessel may be easily damaged or broken when an impact (e.g., an impact caused by a drop or collision) is applied to the dome parts of the pressure vessel. For this reason, a risk of a leak of hydrogen may increase and safety and reliability of the pressure vessel may deteriorate.

Therefore, various studies have been conducted to ensure the structural rigidity of the pressure vessel, and especially the structural rigidity of the dome parts, and improve the safety and reliability of the pressure vessel. Accordingly, there is a need to develop a technology to ensure the structural rigidity of the pressure vessel (e.g., the structural rigidity of the dome parts) and improve the safety and reliability of the pressure vessel.

### SUMMARY

The present disclosure has been made in an effort to provide a pressure vessel assembly capable of minimizing damage to and breakage of a pressure vessel and improving safety and reliability.

In particular, the present disclosure has been made in an effort to ensure and improve structural rigidity and durability of a dome part of a pressure vessel.

Among other things, the present disclosure has been made in an effort to stably maintain an arranged (fastened) state of a protector with respect to the pressure vessel and minimize deformation of and damage to the protector caused by a restraining force of a restraint band.

The present disclosure has also been made in an effort to improve impact absorption performance of the protector and minimize an impact to be applied to the dome part of the pressure vessel when the impact occurs because of an accident or the like.

The present disclosure has also been made in an effort to simplify a structure and a manufacturing process and improve manufacturing efficiency.

The objects to be achieved by the embodiments are not limited to the above-mentioned objects, but also include objects or effects that may be understood from the solutions or embodiments described below.

According to one or more example embodiments of the present disclosure, a pressure vessel assembly may include: a pressure vessel comprising a cylinder, and domes provided at two opposite ends of the cylinder; a protector configured to surround an outer surface of the domes; and a restraint band configured to surround the protector and the pressure vessel, restrain the protector to the pressure vessel, and define exposure regions through which the protector and the pressure vessel are partially exposed.

The restraint band may include a plurality of unit winding circuits, wherein a unit winding circuit of the plurality of unit winding circuits is made by: winding, in a longitudinal direction of the pressure vessel, the restraint band from a first end of the pressure vessel, to a second end of the pressure vessel; and winding the restraint band back from the second end to the first end. A quantity of the plurality of unit winding circuits may be determined based on a diameter of the pressure vessel.

The quantity of unit winding circuits may be a value in a range of 1/60 of the diameter of the pressure vessel to ⅕ of the diameter of the pressure vessel.

The restraint band may include one or more unit filaments configured to continuously traverse the protector and the pressure vessel.

The pressure vessel assembly may further include: a stepped portion provided at one end of the protector so that the restraint band is seated on the stepped portion.

A width of the stepped portion may be greater than or equal to a width of the restraint band.

At least a portion, of the restraint band, that traverses the stepped portion may be wound to be inclined at a first reference angle that is predetermined with respect to a reference line. The reference line may be orthogonal to an axial direction of the pressure vessel.

The first reference angle may be a value in a range of 65 degrees to 87 degrees.

The protector may include: an inner protector portion surrounding the outer surface of the domes and having a first strength; and an outer protector portion having a second strength greater than the first strength and configured to entirely surround a surface of the inner protector portion.

The inner protector portion may have strengths that increase from an inner surface of the inner protector portion toward an outer surface of the inner protector portion.

The outer protector portion may have strengths that increase from an inner surface of the outer protector portion toward an outer surface of the outer protector portion.

The inner protector portion and the outer protector portion may be provided as a unitary one-piece structure by a single process.

The protector may include a curved close contact portion having a curvature, which corresponds to an outer surface of the pressure vessel, and attached to the outer surface of the pressure vessel.

The protector may include a flat surface portion configured to define a part of an outer surface of the protector.

The flat surface portion may be inclined at a reference angle that is predetermined with respect to a reference line in an axial direction of the pressure vessel.

The reference angle may be a value in a range of 30 degrees to 60 degrees.

The pressure vessel assembly may further include: a round portion provided between the stepped portion and the flat surface portion.

The protector may include a curved guide portion configured to guide the restraint band, which traverses the stepped portion, to the cylinder.

A thickness of the protector may increase from a first end of the protector toward a second end of the protector. The first end of the protector may be adjacent to the cylinder.

According to one or more example embodiments of the present disclosure, a pressure vessel assembly may include: a pressure vessel, wherein two opposite ends of the pressure vessel have dome shapes; a protector configured to surround an outer surface of the two opposite ends; and a restraint band configured to surround the protector and the pressure vessel, restrain the protector to the pressure vessel, and define exposure regions through which the protector and the pressure vessel are partially exposed.

A hydrogen electric vehicle may include a pressure vessel configured to store hydrogen (H₂), a fuel cell stack configured to produce electricity by means of an oxidation-reduction reaction between hydrogen and oxygen (O₂), various types of devices configured to discharge produced water, a battery configured to store the electricity produced by the fuel cell stack, a controller configured to convert and control the produced electricity, and a motor configured to generate driving power.

In order to achieve the above-mentioned objects, an exemplary embodiment of the present disclosure provides a pressure vessel assembly including: a pressure vessel including a cylinder part, and dome parts provided at two opposite ends of the cylinder part and each having a dome shape; a protector configured to surround (e.g., envelope, wrap around, etc.) an outer surface of the dome part; and a restraint band configured to surround a periphery of the protector and a periphery of the pressure vessel, restrain the protector to the pressure vessel, and define exposure regions through which the protector and the pressure vessel are partially exposed.

This is to minimize an impact to be applied to the pressure vessel and improve safety and reliability of the pressure vessel.

That is, because of characteristics of the structure of the pressure vessel in the related art in which two opposite dome parts of the pressure vessel each have a dome shape, it is difficult to wind a carbon fiber composite material, with a sufficient thickness, around the dome part of the pressure vessel. For this reason, there is a problem in that it is difficult to ensure sufficient structural rigidity of the dome part of the pressure vessel. In particular, there is a problem in that the pressure vessel is easily damaged or broken when an impact (e.g., an impact caused by a drop or collision) is applied to the dome part of the pressure vessel. For this reason, there are problems in that a risk of a leak of hydrogen increases and safety and reliability of the pressure vessel deteriorate.

### BRIEF DESCRIPTION OF THE DRAWINGS

FIG. 1 is a view for explaining a pressure vessel assembly.

FIGS. 2 and 3 are views for explaining the pressure vessel protector.

FIGS. 4 and 5 are views for explaining a restraint band of the pressure vessel assembly.

FIG. 6 is a view for explaining a modified example of the restraint band of the pressure vessel assembly.

### DETAILED DESCRIPTION

Hereinafter, one or more example embodiments of the present disclosure will be described in detail with reference to the accompanying drawings.

However, the technical spirit of the present disclosure is not limited to some example embodiments described herein but may be implemented in various different forms. One or more of the constituent elements in the example embodiments may be selectively combined and substituted for use within the scope of the technical spirit of the present disclosure.

In addition, unless otherwise specifically and explicitly defined and stated, the terms (including technical and scientific terms) used in the one or more example embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the one or more example embodiments of the present disclosure are for explaining the example embodiments, not for limiting the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

For purposes of this application and the claims, exemplary phrases “a value between A and B” or “a value in a range of A to B” as used herein may mean one or more values selected from a set of values including a value that is equal to A, a value that is equal to B, and values that are greater than A and smaller than B. For example, an integer value in a range of 1 to 10 may mean one or more values selected from a set {1, 2, 3, 4, 5, 6, 7, 8, 9, 10}.

In addition, the terms such as first, second, A, B, (a), and (b) may be used to describe constituent elements of the example embodiments of the present disclosure.

These terms are used only for the purpose of discriminating one constituent element from another constituent element, and the nature, the sequences, or the orders of the constituent elements are not limited by the terms.

Further, when one constituent element is described as being “connected,” “coupled,” or “attached” to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

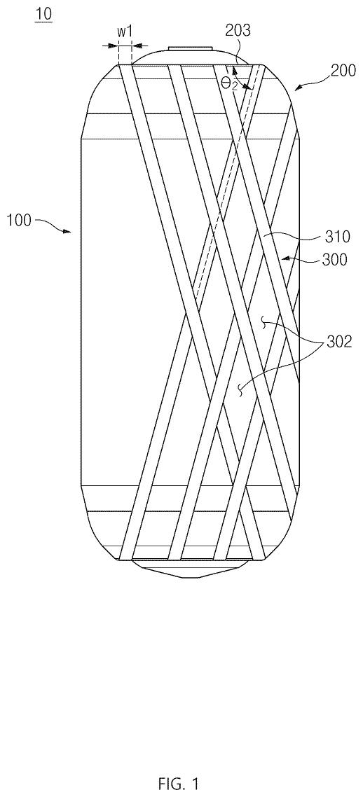

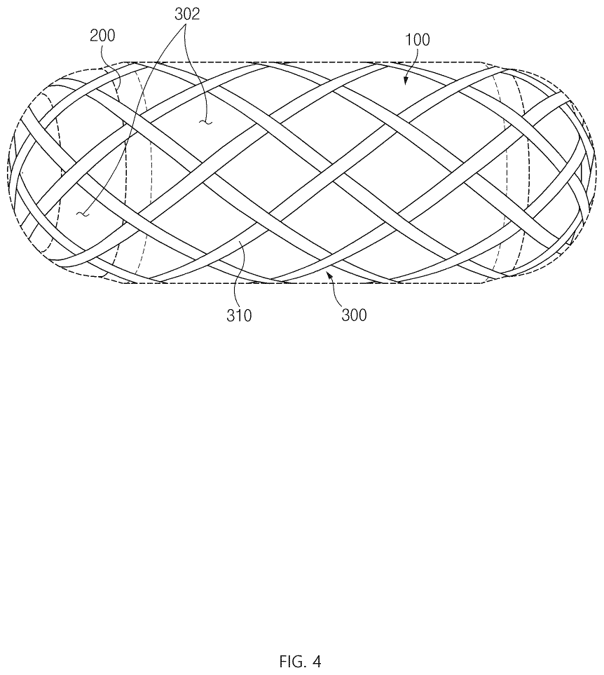

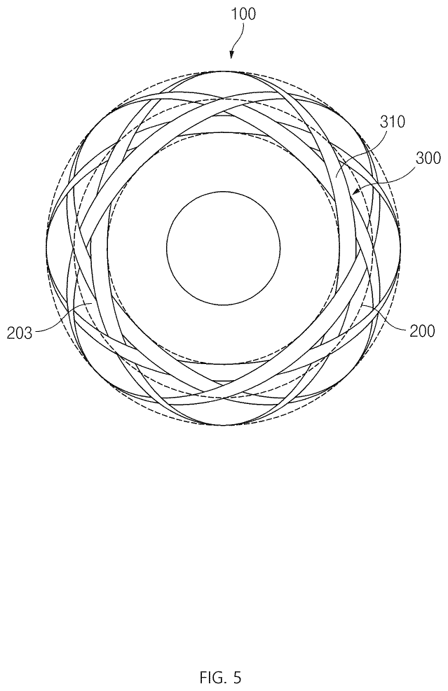

With reference to FIGS. 1 to 6, a pressure vessel assembly 10 may include a pressure vessel 100 including a cylinder part (also referred to as a cylinder) and dome parts (also referred to as domes) provided at two opposite ends of the cylinder part and each having a dome shape, protectors 200 configured to surround outer surfaces of the dome parts, and a restraint band 300 (also referred to as a restraining band) configured to surround a periphery of the protector and a periphery of the pressure vessel, restrain the protector to the pressure vessel, and define exposure regions 302 through which the protector and the pressure vessel are partially exposed.

The pressure vessel assembly 10 may be used to store a high-pressure fluid (liquid or gas). The present disclosure is not restricted or limited by the type and the properties of the fluid stored in the pressure vessel 100.

Hereinafter, one or more examples will be described in which the pressure vessel assembly 10 may be used as a hydrogen tank for a hydrogen storage system applied to mobility vehicles such as various fuel cell vehicles (e.g., a truck), ships, and aircraft to which a fuel cell stack may be applied.

The pressure vessel 100 may store a high-pressure fluid (e.g., hydrogen) therein.

The pressure vessel 100 may have various structures in accordance with required conditions and design specifications. The present disclosure is not restricted or limited by the structure of the pressure vessel 100.

The pressure vessel 100 may include a liner 110 having a storage space therein, and a carbon fiber layer 120 configured to surround an outer surface of the liner 110. The pressure vessel 100 may be selectively expanded or contracted depending on a pressure of a fluid (e.g., hydrogen) stored in the pressure vessel 100.

The liner 110 may have a hollow structure having the storage space therein, and high-pressure compressed hydrogen may be stored in the storage space.

The liner 110 may be variously changed in material in accordance with required conditions and design specifications. The present disclosure is not restricted or limited by the material of the liner 110.

In particular, the liner 110 may be made of a nonmetallic material such as high-density plastic with excellent restoring force and excellent fatigue resistance. Alternatively, the liner may be made of a metallic material (e.g., aluminum) or other materials.

The carbon fiber layer 120 may surround the entire outer surface of the liner 110.

The carbon fiber layer 120 may be made of various materials in accordance with required conditions and design specifications. The present disclosure is not restricted or limited by the material and properties of the carbon fiber layer 120.

For example, the carbon fiber layer 120 may be provided by winding a composite material, which is made by impregnating a carbon fiber with epoxy and thermosetting or thermoplastic resin, and tow prepreg, which is impregnated with resin in advance, around the outer surface of the liner 110.

The structure of the wound carbon fiber composite material and the method of winding the carbon fiber composite material may be variously changed in accordance with required conditions and design specifications. The present disclosure is not limited or restricted by the method of winding the carbon fiber composite material.

The carbon fiber layer 120 may be provided by winding multiple layers of the carbon fiber composite material around the outer surface of the liner 110 in various patterns (e.g., clockwise winding, counterclockwise winding, oblique winding, etc.).

For example, the carbon fiber composite material may be wound around the outer surface of the liner 110 by a winding jig (not illustrated). The winding angle of the carbon fiber composite material with respect to the liner 110 may be changed by adjusting an angle (posture) at which the winding jig is disposed with respect to the liner 110.

The carbon fiber composite material wound around the outer surface of the liner 110 may be cured through a subsequent heat treatment process, thereby forming the carbon fiber layer 120. As an example, the carbon fiber composite material wound around the outer surface of the liner 110 may be cured by performing heat treatment at a temperature of 90° C. or higher for a predetermined time.

More specifically, the pressure vessel 100 may include a cylinder part 102 (also referred to as cylinder), and dome parts 104 (also referred to as domes). The dome parts 104 may be provided at two opposite ends of the cylinder part 102 and each having a dome shape.

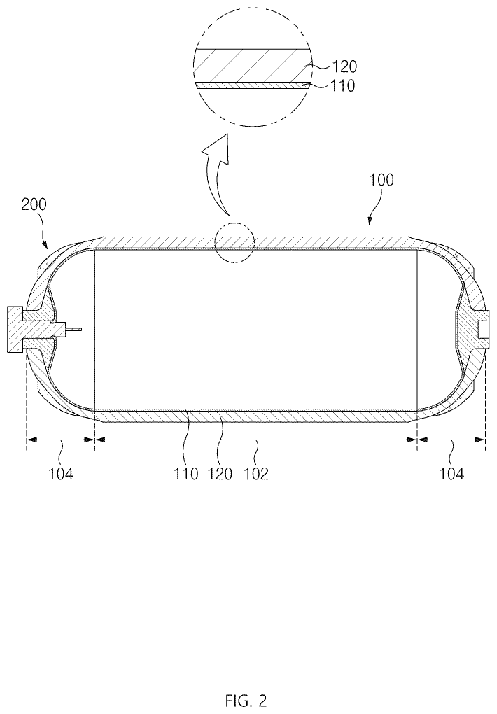

The cylinder part 102 may have an approximately hollow cylindrical shape. The dome parts 104 each having a dome shape may be integrally provided at one end (a left end as shown in FIG. 2) and the other end (a right end as shown in FIG. 2) of the cylinder part 102.

An inlet/outlet port (not illustrated) may be provided at an end of the dome part 104, and hydrogen may enter or exit the dome part 104 through the inlet/outlet port. Various types of components, such as a valve and a pipe, may be connected to the inlet/outlet port.

The protector 200 may be configured to ensure structural rigidity of the dome part 104, minimize an impact to be transmitted to the dome part 104 of the pressure vessel 100 if the impact occurs because of an accident or the like, and minimize damage to and breakage of the pressure vessel 100.

The protector 200 may have various structures capable of surrounding the outer surface of each of the dome parts 104. The present disclosure is not restricted or limited by the structure and shape of the protector 200.

The protector 200 may be provided to have a dome shape corresponding to the dome part 104 and configured to partially surround the outer surface of the dome part 104 (the protector 200 is provided in a ring shape). Alternatively, the protector may surround the entire outer surface of the dome part.

The protector 200 may include an inner protector portion 210 provided to surround the outer surface of the dome part 104 and having a first strength, and an outer protector portion 220 having a second strength higher than the first strength and configured to surround an entire surface of the inner protector portion 210.

The configuration in which the outer protector portion 220 surrounds the entire surface of the inner protector portion 210 may be defined as a configuration in which the outer protector portion 220 surrounds both an inner surface of the inner protector portion 210 (an inner surface facing an outer peripheral surface of the pressure vessel) and an outer surface of the inner protector portion 210.

This is based on the fact that when an impact, which is applied to the protector 200 by a drop, a collision, or the like, is transmitted to the dome part 104 of the pressure vessel 100 in an intact manner, the carbon fiber layer 120 corresponding to the dome part 104 of the pressure vessel 100 may be easily damaged or broken.

In contrast, the protector 200 may be provided to surround the outer surface of the dome part 104, and the protector 200 may include the inner protector portion 210 and the outer protector portion 220 having different strengths, such that the inner protector portion may absorb (mitigate) the impact force applied to the protector 200. Therefore, it may be possible to obtain an advantageous effect of minimizing an impact to be transmitted to the pressure vessel 100 through the protector 200 if the impact occurs because of an accident or the like, and an advantageous effect of minimizing damage to and breakage of the pressure vessel 100.

The protector 200 may have various structures including the inner protector portion 210 and the outer protector portion 220. The present disclosure is not restricted or limited by the structure and shape of the protector 200 including the inner protector portion 210 and the outer protector portion 220.

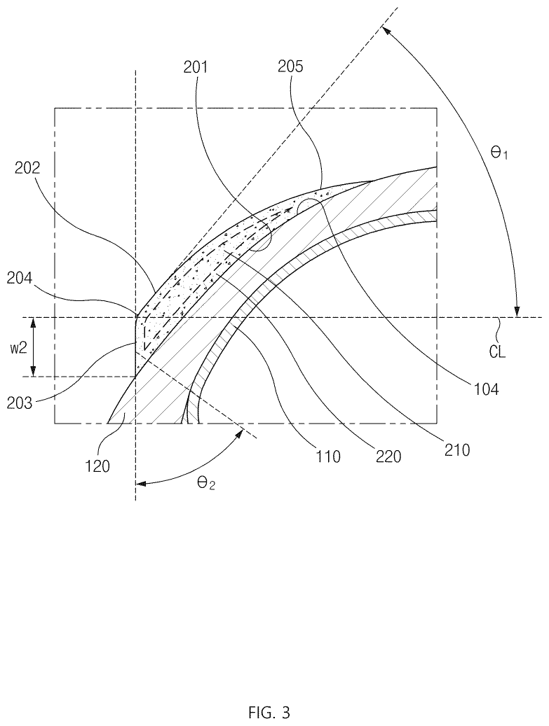

The protector 200 may be provided to have a thickness that gradually increases from one end (e.g., a right end as shown in FIG. 3) adjacent to the cylinder part 102 toward the other end (e.g., a left end as shown in FIG. 3).

The protector 200 may have a thickness that gradually increases from one end, which is adjacent to the cylinder part 102, toward the other end. Alternatively, the protector may be configured to have an entirely uniform thickness or configured such that a particular site of the protector is partially thick (or thin) in thickness.

The inner protector portion 210 may be provided to have strength that gradually increases from the inside toward the outside thereof.

In this case, the configuration in which the inner protector portion 210 may have the strength that gradually increases from the inside toward the outside thereof may be understood as a configuration in which the strength of the inner protector portion 210 gradually increases from the inside (e.g., a central portion of the inner protector portion) toward the outside (e.g., an outermost peripheral portion of the inner protector portion). In other words, the inner protector portion 210 may have the highest strength on the outside (e.g., an outer surface of the inner protector portion 210) and have the lowest strength on the inside (e.g., an inner surface of the inner protector portion 210).

The outer protector portion 220 may be provided to have strength that gradually increases from the inside toward the outside thereof.

In this case, the configuration in which the outer protector portion 220 has the strength that gradually increases from the inside toward the outside may be understood as a configuration in which the strength of the outer protector portion 220 gradually increases from the inside (e.g., an inner surface of the outer protector portion adjacent to the inner protector portion) toward the outside (e.g., an outer surface of the outer protector portion). In other words, the outer protector portion 220 may have the highest strength on the outside and have the lowest strength on the inside.

The inner protector portion 210 and the outer protector portion 220 each may have strength that gradually increases from the inside toward the outside. Alternatively, the inner protector portion and the outer protector portion may each be configured to have entirely constant strength.

The protector 200 including the inner protector portion 210 and the outer protector portion 220 having different strengths may be manufactured in various ways in accordance with required conditions and design specifications. The present disclosure is not restricted or limited by the method of manufacturing the protector 200.

The inner protector portion 210 and the outer protector portion 220 may be provided as a unitary one-piece (e.g., unibody, single-body, single-piece) structure by a single process.

The protector 200 may be provided by foaming a raw foaming material in a direction from the dome part 104 toward the cylinder part 102 and then cooling the raw foaming material. The outer protector portion 220 may have a higher density than the inner protector portion 210 by adjusting a foaming speed or time, such that the outer protector portion 220 may have higher rigidity (strength) than the inner protector portion 210. In particular, the protector 200 may be formed by a typical open mold foaming process method.

The raw foaming material for forming the protector 200 may be various materials in accordance with required conditions and design specifications. The present disclosure is not restricted or limited by the material and properties of the raw foaming material.

A typical polymer material may be used as the raw foaming material for forming the protector 200.

This is based on the fact that the pressure vessel 100 may be repeatedly expanded or contracted. Because a polymer material having high durability is used as the raw foaming material for the protector 200, it may be possible to obtain an advantageous effect of stably ensuring durability of the protector 200 even though the pressure vessel 100 is repeatedly expanded or contracted.

More particularly, a low-density thermosetting polymer material (e.g., polyurethane foam (PUF) or expanded polypropylene (EPP)) may be used as the raw foaming material.

As described above, the polymer material with low-density properties (e.g., 150 to 400 kg/m³) may be used as the raw foaming material, which may ensure the impact absorption performance of the protector 200, reduce (e.g., minimize) damage to (e.g., deformation of) the protector 200 caused by tension of the restraint band 300 (e.g., tension by which the restraint band is wound around the protector), and contribute to a reduction in weight of the protector 200. In addition, because the raw foaming material has thermosetting properties, it may be possible to obtain an advantageous effect of minimizing deformation of the protector 200 and deterioration in impact absorption performance caused by exposure to heat (e.g., an increase in temperature of a surrounding environment).

In addition, various additives, such as a refractory material (e.g., expanded graphite), may be added to the raw foaming material for forming the protector 200 in order to improve resistance when the protector 200 is exposed to flame. The present disclosure is not restricted or limited by the type and properties of the additive.

The inner protector portion 210 and the outer protector portion 220 may be simultaneously formed by the foaming process. Alternatively, the inner protector portion may be formed first, and then the outer protector portion may be formed to surround the periphery of the inner protector portion by insert-injection molding.

The protector 200 may include a curved close contact portion 201 having a curvature, which corresponds to an outer surface of the pressure vessel 100, and tightly attached to the outer surface of the pressure vessel 100.

For example, the curved close contact portion 201 may be entirely provided on an inner surface of the protector 200 that faces the outer surface of the pressure vessel 100.

As described above, the curved close contact portion 201 is provided on the inner surface of the protector 200, and the curved close contact portion 201 is tightly attached to the outer surface of the pressure vessel 100. Therefore, it may be possible to obtain an advantageous effect of ensuring a sufficient contact area between the pressure vessel 100 and the curved close contact portion 201 and improving impact resistance performance implemented by the protector 200.

The protector 200 may be provided to have a thickness that gradually increases from one end (e.g., the right end as shown in FIG. 3) adjacent to the cylinder part 102 toward the other end (e.g., the left end as shown in FIG. 3), and a change in thickness of the protector 200 may be configured such that the thickness of the protector 200 does not decrease by, for example, 1 mm or more per 2 mm of a length of the protector 200. As described above, the change in thickness of the protector 200 may be configured such that the thickness of the protector 200 does not decrease by, for example, 1 mm or more per 2 mm of the length of the protector 200, such that a high-strength region (the outer protector portion) may be locally provided in the protector 200. Therefore, it may be possible to obtain an advantageous effect of improving the impact absorption performance of the protector 200.

The protector 200 may include a flat surface portion 202 configured to define a part of the outer surface of the protector 200.

The flat surface portion 202 may be provided to minimize an impact to be transmitted to the pressure vessel 100 through the protector 200 when the pressure vessel 100 falls onto (or collides with) a ground surface.

That is, when the outer surface of the protector is provided as a curved surface, there may be a problem in that when the protector falls onto the ground surface or the like, the outer surface of the protector comes into point contact with the ground surface, and stress is concentrated at an impact portion of the protector (the portion being in contact with the ground surface). For this reason, there may be a problem in that the protector is easily damaged, and an impact to be transmitted to the pressure vessel is increased.

In contrast, the flat surface portion 202 having a straight (flat) shape may be provided on the outer surface of the protector 200, and the flat surface portion 202 may come into line contact or surface contact with the ground surface when the protector 200 falls onto the ground surface or the like, such that an impact and stress applied to the protector 200 may be uniformly dispersed along the flat surface portion 202. Therefore, it may be possible to obtain an advantageous effect of minimizing damage to the protector 200 and reducing an impact to be transmitted to the pressure vessel 100.

The flat surface portion 202 may be provided to be inclined at a second reference angle θ₁ preset with respect to a reference line CL defined in an axial direction of the pressure vessel 100.

The second reference angle θ₁ may be variously changed in accordance with required conditions and design specifications. The present disclosure is not restricted or limited by the size of the second reference angle θ₁.

The second reference angle θ₁ may be defined as, for example, between 30 and 60 degrees. In particular, the second reference angle θ₁ may be defined as, for example, 45 degrees.

The restraint band 300 may be provided to restrain the protector to the pressure vessel while partially surrounding the periphery of the protector and the periphery of the pressure vessel. The restraint band 300 may be configured to define the exposure regions 302 through which the protector and the pressure vessel are partially exposed.

In this case, the configuration in which the restraint band 300 partially surrounds the periphery of the protector and the periphery of the pressure vessel may be defined as a configuration in which the restraint band 300 partially covers a peripheral surface of the protector and a peripheral surface of the pressure vessel without covering the entire peripheral surface of the protector and the entire peripheral surface of the pressure vessel.

This is based on the fact that when the restraint band 300 is configured to surround the entire periphery of the protector, a restraining force (e.g., a fastening force for fastening the protector to the pressure vessel) applied by the restraint band 300 may be increased, but excessive stress is concentrated on the protector by tension applied to the restraint band 300 when the pressure vessel is expanded or contracted, which may cause deformation of and damage to the protector.

In contrast, the restraint band 300 may partially surround the periphery of the protector and the periphery of the pressure vessel without surrounding the entire periphery of the protector and the entire periphery of the pressure vessel so that the protector and the pressure vessel may be partially exposed (e.g., exposed through the exposure regions), such that excessive stress (e.g., excessive restraining force applied by the restraint band) may be inhibited from being applied to the protector. Therefore, it may be possible to obtain an advantageous effect of minimizing deformation of and damage to the protector caused by the restraining force of the restraint band 300.

The restraint band 300 may have various structures capable of partially surrounding the periphery of the protector and defining the exposure regions 302 (e.g., the regions through which the protector and the pressure vessel are exposed to the outside). The present disclosure is not restricted or limited by the structure and shape of the restraint band 300.

The restraint band 300 may include one or more unit filaments 310 configured to continuously traverse the periphery of the protector and the periphery of the pressure vessel.

For example, with reference to FIGS. 1, 4, and 5, the restraint band 300 may be provided by continuously winding the unit filament (or unit bobbin) 310, which has an approximately continuous band shape, around the periphery of the protector and the periphery of the pressure vessel.

The number and width of the unit filament 310, which constitutes the restraint band 300, may be variously changed on the basis of a size (e.g., a diameter) of the pressure vessel. The present disclosure is not restricted or limited by the number and width of the unit filament 310 that constitutes the restraint band 300.

For example, the restraint band 300 may be provided by continuously winding only one unit filament 310 in an approximately ‘X’ shape around the periphery of the protector and the periphery of the pressure vessel, and portions of the unit filament 310, which intersect one another, may collectively define the exposure regions 302 each having an approximately rhombic shape.

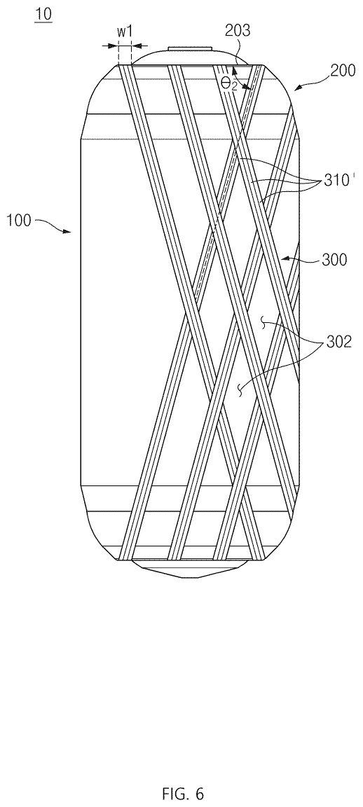

Alternatively, the restraint band 300 may be configured by winding a plurality of unit filaments 310′ (or a plurality of unit bobbins) around the periphery of the protector and the periphery of the pressure vessel. For example, with reference to FIG. 6, the restraint band 300 may be provided by continuously winding three unit filaments 310′. Alternatively, the restraint band may include two or fewer unit filaments or include four or more unit filaments.

The restraint band 300 may be made of various materials in accordance with required conditions and design specifications. The present disclosure is not restricted or limited by the material and properties of the restraint band 300.

The unit filament 310, which constitutes the restraint band 300, may be made of a material identical or similar to that of the carbon fiber layer 120 (e.g., a carbon fiber composite material made by impregnating a carbon fiber with epoxy, thermosetting resin, and the like). Alternatively, the restraint band 300 may be made of a material (e.g., metal or ceramic) different from that of the carbon fiber layer.

If a circuit, which is made by winding the restraint band 300 from one end of the pressure vessel based on a longitudinal direction of the pressure vessel to the other end of the pressure vessel and then winding the restraint band 300 back to one end of the pressure vessel from the other end of the pressure vessel, is defined as a unit winding circuit, the number (e.g., the quantity) of unit winding circuits may be determined depending on a diameter of the pressure vessel.

In this case, the unit winding circuit may be defined as a unit made by continuously winding the restraint band 300 in an approximately ‘X’ shape around the periphery of the protector and the periphery of the pressure vessel.

The number (e.g., the quantity) of unit winding circuits (e.g., unit windings) may be defined as, for example, a quantity between 1/60 and ⅕ of the diameter of the pressure vessel. For example, when the diameter of the pressure vessel is 300 mm, the restraint band 300 may be wound around the pressure vessel to define five to sixty unit winding circuits.

That is, if the number of unit winding circuits is smaller than, for example, 1/60 of the diameter of the pressure vessel, it may be difficult to stably ensure the restraining force applied by the restraint band 300. When the number of unit winding circuits is larger than, for example, ⅕ of the diameter of the pressure vessel, the restraining force applied by the restraint band 300 may be excessively increased, and excessive stress may be applied to the protector. Therefore, the number of unit winding circuits may be defined as, for example, a quantity between 1/60 and ⅕ of the diameter of the pressure vessel.

Tension of the unit filament 310, which constitutes the restraint band 300, may be variously changed in accordance with required conditions and design specifications. The present disclosure is not restricted or limited by the tension of the unit filament 310.

The tension of the unit filament 310, which constitutes the restraint band 300, may be defined as, for example, between 1 and 10 kgf so that durability and impact resistance performance may be ensured by tightly attaching the protector to the pressure vessel while inhibiting the restraint band 300 from being loosened when the pressure vessel is expanded and restrained.

The protector 200 may include a stepped portion 203 provided at one end (e.g., a left end as shown in FIG. 3) of the flat surface portion 202 so that the restraint band 300 configured to restrain the protector 200 to the pressure vessel 100 is seated on the stepped portion 203.

The stepped portion 203 is provided to minimize a slip of the restraint band 300 relative to the protector 200, stably maintain tension applied by the restraint band 300 without damaging the restraint band 300, and inhibit the protector 200 from separating from the pressure vessel 100.

The stepped portion 203 may have various structures capable of defining the seating surface on which the restraint band 300 is seated. The present disclosure is not restricted or limited by the structure and shape of the stepped portion 203.

For example, the stepped portion 203 may have a straight (flat) shape. Alternatively, the stepped portion may have a spline, geodesic, or elliptical shape or other shapes.

In particular, the stepped portion 203 may be provided to protrude in an embossed shape with respect to a perpendicular reference line (not illustrated) orthogonal to the reference line CL defined in the axial direction (e.g., longitudinal direction) of the pressure vessel 100.

In this case, the configuration in which the stepped portion 203 protrudes in an embossed shape with respect to the perpendicular reference line SL may be defined as a configuration in which one end of the stepped portion 203 (e.g., a lower end of the stepped portion as shown in FIG. 3) adjacent to the outermost peripheral end of the dome part 104 is disposed to be closer to an outermost peripheral end of the dome part 104 based on the perpendicular reference line SL than the other end of the stepped portion 203 (e.g., an upper end of the stepped portion as shown in FIG. 3) to the outermost peripheral end of the dome part 104 (e.g., one end of the stepped portion 203 is disposed to be biased in a leftward direction as shown in FIG. 3).

As described above, the stepped portion 203 protrudes in an embossed shape instead of a debossed shape based on the perpendicular reference line SL, and the tension applied by the restraint band 300 may be uniformly dispersed to the stepped portion 203 without being concentrated at an edge portion of the stepped portion 203 (a section between the stepped portion and the flat surface portion). Therefore, it is possible to obtain an advantageous effect of minimizing deformation of and damage to the protector 200 caused by the tension of the restraint band 300.

The restraint band 300 may be provided to have a first width (see W1 in FIG. 1), and the stepped portion 203 may be provided to have a second width (see W2 in FIG. 3) equal to or larger than the first width.

Because the stepped portion 203 has the second width W2 equal to or larger than the first width W1 of the restraint band 300 as described above, it is possible to obtain an advantageous effect of minimizing a slip of the restraint band 300 and stably maintaining the state in which the restraint band 300 is seated on the stepped portion 203.

The restraint band 300, which traverses the stepped portion 203, may be wound to be inclined at a first reference angle θ₂ preset with respect to the perpendicular reference line (not illustrated) orthogonal to the reference line CL defined in the axial direction of the pressure vessel 100.

The first reference angle θ₂ may be variously changed in accordance with required conditions and design specifications. The present disclosure is not restricted or limited by the size of the first reference angle θ₂.

The first reference angle θ₂ may be defined as, for example, between 65 and 87 degrees.

This is based on the fact that when a winding angle (the first reference angle) of the restraint band 300 with respect to the stepped portion 203 is smaller than 65 degrees or larger than 87 degrees, the restraint band 300 slips relative to the stepped portion 203, which makes it difficult to accurately wind the restraint band 300 at a required posture and a required position. The winding angle (first reference angle) of the restraint band 300 with respect to the stepped portion 203 may be defined as, for example, between 65 and 87 degrees. Therefore, it is possible to obtain an advantageous effect of minimizing a slip of the restraint band 300 relative to the stepped portion 203 and accurately winding the restraint band 300 at the required posture and position.

The protector 200 may include a round portion 204 defined between the stepped portion 203 and the flat surface portion 202.

The round portion 204 may be provided between the stepped portion 203 and the flat surface portion 202, such that a situation in which the restraint band 300, which is wound around the flat surface portion 202 while traversing the stepped portion 203, is rapidly bent may be minimized, and a situation in which stress is concentrated at the edge portion of the stepped portion 203 (the section between the stepped portion and the flat surface portion) may be minimized. Therefore, it is possible to obtain an advantageous effect of minimizing deformation of and damage to the protector 200 caused by the tension of the restraint band 300.

The example has been described in which the round portion 204 is provided between the stepped portion 203 and the flat surface portion 202. Alternatively, a chamfered portion, instead of the round portion, may be provided between the stepped portion and the flat surface portion.

The protector 200 may include a curved guide portion 205 provided at the other end (e.g., a right end as shown in FIG. 3) of the flat surface portion 202 and configured to guide the restraint band 300, which has traversed the stepped portion 203, to the cylinder part 102.

The curved guide portion 205 may have various structures in accordance with required conditions and design specifications. The present disclosure is not restricted or limited by the structure and shape of the curved guide portion 205. For example, the curved guide portion 205 may be provided to have a spline, geodesic, or elliptical structure.

The restraint band 300, which has traversed the flat surface portion 202, may be wound around the outer surface of the cylinder part 102 while traversing the curved guide portion 205 having a predetermined curvature, such that the restraint band 300 may be more effectively tightly attached to the protector 200 and the pressure vessel 100. Therefore, it is possible to obtain an advantageous effect of further increasing the restraining force applied by the restraint band 300 (the restraining force applied to the protector against the pressure vessel), more securely maintaining the arrangement state of the protector 200 with respect to the pressure vessel 100, and minimizing the separation of the protector 200.

Meanwhile, a degassing portion may be defined at one end (e.g., the right end as shown in FIG. 3) of the protector 200 adjacent to the cylinder part 102 to discharge gas during a foaming process for forming the protector 200.

For reference, the degassing portion may be defined by a gap between the pressure vessel 100 and a mold (not illustrated) provided to surround the periphery of the pressure vessel 100 to perform the foaming process for forming the protector 200.

In particular, a width (thickness) of the degassing portion may be defined as, for example, between 0.2 and 1.8% of an outer diameter of the protector 200. That is, when the width (thickness) of the degassing portion is smaller than 0.2% of the outer diameter of the protector 200, the foaming process reaction cannot be smoothly performed, and an unreacted region and an air pocket are likely to occur, which may adversely affect the impact absorption performance of the protector 200. When the width (thickness) of the degassing portion is larger than 1.8% of the outer diameter of the protector 200, the foaming process reaction occurs excessively, which causes a problem in that it is difficult to form a high-strength surface dense region (the outer protector portion). Therefore, the width (thickness) of the degassing portion may be defined as, for example, between 0.2 and 1.8% of the outer diameter of the protector 200.

In contrast, the protector may be provided to cover the outer surface of the dome part, and the protector is restrained to the pressure vessel by means of the restraint band provided to partially surround the periphery of the protector and the periphery of the pressure vessel. Therefore, it is possible to obtain an advantageous effect of stably maintaining the arranged (fastened) state of the protector with respect to the pressure vessel and minimizing deformation of and damage to the protector caused by the restraining force of the restraint band.

The restraint band may partially surround the periphery of the protector and the periphery of the pressure vessel without surrounding the entire periphery of the protector and the entire periphery of the pressure vessel so that the protector and the pressure vessel may be partially exposed, such that excessive stress (excessive restraining force applied by the restraint band) may be inhibited from being applied to the protector. Therefore, it is possible to obtain an advantageous effect of minimizing deformation of and damage to the protector caused by the restraining force of the restraint band.

The restraint band may have various structures capable of partially surrounding the periphery of the protector and defining the exposure regions (the regions through which the protector and the pressure vessel are exposed to the outside).

The restraint band may include one or more unit filaments configured to continuously traverse the periphery of the protector and the periphery of the pressure vessel.

When a circuit, which is made by winding the restraint band from one end of the pressure vessel based on a longitudinal direction of the pressure vessel to the other end of the pressure vessel and then winding the restraint band back to one end of the pressure vessel from the other end of the pressure vessel, is defined as a unit winding circuit, the number of unit winding circuits may be determined depending on a diameter of the pressure vessel.

The number of unit winding circuits may be defined as 1/60 to ⅕ of the diameter of the pressure vessel.

That is, when the number of unit winding circuits is smaller than 1/60 of the diameter of the pressure vessel, it is difficult to stably ensure the restraining force applied by the restraint band. When the number of unit winding circuits is larger than ⅕ of the diameter of the pressure vessel, the restraining force applied by the restraint band may be excessively increased, and excessive stress may be applied to the protector. Therefore, the number of unit winding circuits may be defined as 1/60 to ⅕ of the diameter of the pressure vessel.

The protector may include a stepped portion provided at one end of the flat surface portion so that the restraint band configured to restrain the protector to the pressure vessel is seated on the stepped portion.

The protector has the stepped portion, and the restraint band is seated on the stepped portion. Therefore, it is possible to obtain an advantageous effect of minimizing a slip of the restraint band relative to the protector, stably maintaining the tension applied by the restraint band without damaging the restraint band, and inhibiting the protector from separating from the pressure vessel (improving the fastening force).

The restraint band may be provided to have a first width, and the stepped portion 203 may be provided to have a second width equal to or larger than the first width.

Because the stepped portion has the second width equal to or larger than the first width of the restraint band as described above, it is possible to obtain an advantageous effect of minimizing a slip of the restraint band and stably maintaining the state in which the restraint band is seated on the stepped portion.

The restraint band, which traverses the stepped portion, may be wound to be inclined at a first reference angle preset with respect to the perpendicular reference line orthogonal to the reference line defined in the axial direction of the pressure vessel.

The first reference angle may be variously changed in accordance with required conditions and design specifications.

The first reference angle may be defined to be 65 to 87 degrees.

This is based on the fact that when a winding angle (the first reference angle) of the restraint band with respect to the stepped portion is smaller than 65 degrees or larger than 87 degrees, the restraint band slips relative to the stepped portion, which makes it difficult to accurately wind the restraint band at a required posture and a required position. The winding angle (first reference angle) of the restraint band with respect to the stepped portion may be defined as 65 to 87 degrees. Therefore, it is possible to obtain an advantageous effect of minimizing a slip of the restraint band relative to the stepped portion and accurately winding the restraint band at the required posture and position.

The protector may have various structures capable of surrounding the outer surface of the dome part.

The protector may include an inner protector portion provided to surround the outer surface of the dome part and having a first strength, and an outer protector portion having a second strength higher than the first strength and configured to surround an entire surface of the inner protector portion.

This is based on the fact that when an impact, which is applied to the protector by a drop, a collision, or the like, is transmitted to the dome part of the pressure vessel in an intact manner, the carbon fiber layer corresponding to the dome part of the pressure vessel may be easily damaged or broken.

In contrast, the protector may be provided to surround the outer surface of the dome part, and the protector includes the inner protector portion and the outer protector portion having different strengths, such that the inner protector portion may absorb (mitigate) the impact force applied to the protector. Therefore, it is possible to obtain an advantageous effect of minimizing an impact to be transmitted to the pressure vessel through the protector when the impact occurs because of an accident or the like, and an advantageous effect of minimizing damage to and breakage of the pressure vessel.

The protector may have various structures including the inner protector portion and the outer protector portion.

The protector may be provided to have a thickness that gradually increases from one end, which is adjacent to the cylinder part, toward the other end.

The inner protector portion may be provided to have strength that gradually increases from the inside toward the outside thereof.

The outer protector portion may be provided to have strength that gradually increases from the inside toward the outside thereof.

The protector including the inner protector portion and the outer protector portion having different strengths may be manufactured in various ways in accordance with required conditions and design specifications.

The inner protector portion and the outer protector portion may be provided as a unitary one-piece structure by a single process.

The protector may be provided by foaming a raw foaming material in a direction from the dome part toward the cylinder part, and the outer protector portion may have a higher density than the inner protector portion.

The protector may include a curved close contact portion having a curvature, which corresponds to an outer surface of the pressure vessel, and tightly attached to the outer surface of the pressure vessel.

As described above, the curved close contact portion is provided on the inner surface of the protector, and the curved close contact portion is tightly attached to the outer surface of the pressure vessel. Therefore, it is possible to obtain an advantageous effect of ensuring a sufficient contact area between the pressure vessel and the curved close contact portion and improving impact resistance performance implemented by the protector.

The protector may include a flat surface portion configured to define a part of the outer surface of the protector.

This is based on the fact that when the outer surface of the protector is provided as a curved surface, there is a problem in that when the protector falls onto the ground surface or the like, the outer surface of the protector comes into point contact with the ground surface, and stress is concentrated at an impact portion of the protector (the portion being in contact with the ground surface), and for this reason, there is a problem in that the protector is easily damaged, and an impact to be transmitted to the pressure vessel is increased.

In contrast, the flat surface portion having a straight (flat) shape may be provided on the outer surface of the protector, and the flat surface portion may come into line contact or surface contact with the ground surface when the protector falls onto the ground surface or the like, such that an impact and stress applied to the protector may be uniformly dispersed along the flat surface portion. Therefore, it is possible to obtain an advantageous effect of minimizing damage to the protector and reducing an impact to be transmitted to the pressure vessel.

The flat surface portion may be provided to be inclined at a second reference angle preset with respect to a reference line defined in an axial direction of the pressure vessel.

The second reference angle may be variously changed in accordance with required conditions and design specifications.

The second reference angle may be defined to be 30 to 60 degrees. In particular, the second reference angle may be defined as 45 degrees.

The protector may include a round portion defined between the stepped portion and the flat surface portion.

The round portion may be provided between the stepped portion and the flat surface portion, such that a situation in which the restraint band, which is wound around the flat surface portion while traversing the stepped portion, is rapidly bent may be minimized, and a situation in which stress is concentrated at the edge portion of the stepped portion (the section between the stepped portion and the flat surface portion) may be minimized. Therefore, it is possible to obtain an advantageous effect of minimizing deformation of and damage to the protector caused by the tension of the restraint band.

The protector may include a curved guide portion provided at the other end of the flat surface portion and configured to guide the restraint band, which has traversed the stepped portion, to the cylinder part.

The restraint band, which has traversed the flat surface portion, is wound around the outer surface of the cylinder part while traversing the curved guide portion having a predetermined curvature, such that the restraint band may be more effectively tightly attached to the protector and the pressure vessel. Therefore, it is possible to obtain an advantageous effect of further increasing the restraining force applied by the restraint band (the restraining force applied to the protector against the pressure vessel), more securely maintaining the arrangement state of the protector with respect to the pressure vessel, and minimizing the separation of the protector.

It may be possible to obtain an advantageous effect of minimizing damage to and breakage of the pressure vessel and improving safety and reliability.

In particular, it may be possible to obtain an advantageous effect of ensuring the structural rigidity of the dome part of the pressure vessel and improving the durability.

Among other things, it may be possible to obtain an advantageous effect of stably maintaining the arranged (fastened) state of the protector with respect to the pressure vessel and minimizing deformation of and damage to the protector caused by the restraining force of the restraint band.

In addition, it may be possible to obtain an advantageous effect of improving the impact absorption performance of the protector and minimizing an impact to be transmitted to the dome part of the pressure vessel when the impact occurs because of an accident or the like.

In addition, it may be possible to obtain an advantageous effect of stably maintaining the fastened state of the pressure vessel and the protector and minimizing the separation of the protector when the pressure vessel is contracted or expanded.

In addition, it may be possible to obtain an advantageous effect of simplifying the structure and manufacturing process and improving the manufacturing efficiency.

While one or more example embodiments have been described above, the example embodiments are just illustrative and not intended to limit the present disclosure. It can be appreciated by those skilled in the art that various modifications and applications, which are not described above, may be made to the one or more example embodiments without departing from the intrinsic features of the example embodiment. For example, the respective constituent elements specifically described in the example embodiments may be modified and then carried out. Further, it should be interpreted that the differences related to the modifications and applications are included in the scope of the present disclosure defined by the appended claims.

What is claimed is:

1. A pressure vessel assembly comprising:
a pressure vessel comprising:
a cylinder, and
domes provided at two opposite ends of the cylinder;
a protector configured to surround an outer surface of the domes; and
a restraint band configured to surround the protector and the pressure vessel, restrain the protector to the pressure vessel, and define exposure regions through which the protector and the pressure vessel are partially exposed.

2. The pressure vessel assembly of claim 1, wherein the restraint band comprises a plurality of unit winding circuits, wherein a unit winding circuit of the plurality of unit winding circuits is made by:
winding, in a longitudinal direction of the pressure vessel, the restraint band from a first end of the pressure vessel, to a second end of the pressure vessel; and
winding the restraint band back from the second end to the first end, and
wherein a quantity of the plurality of unit winding circuits is determined based on a diameter of the pressure vessel.

3. The pressure vessel assembly of claim 2, wherein the quantity of unit winding circuits is a value in a range of 1/60 of the diameter of the pressure vessel to ⅕ of the diameter of the pressure vessel.

4. The pressure vessel assembly of claim 1, wherein the restraint band comprises one or more unit filaments configured to continuously traverse the protector and the pressure vessel.

5. The pressure vessel assembly of claim 1, further comprising:
a stepped portion provided at one end of the protector so that the restraint band is seated on the stepped portion.

6. The pressure vessel assembly of claim 5, wherein a width of the stepped portion is greater than or equal to a width of the restraint band.

7. The pressure vessel assembly of claim 5, wherein at least a portion, of the restraint band, that traverses the stepped portion is wound to be inclined at a first reference angle that is predetermined with respect to a reference line, which is orthogonal to an axial direction of the pressure vessel.

8. The pressure vessel assembly of claim 7, wherein the first reference angle is a value in a range of 65 degrees to 87 degrees.

9. The pressure vessel assembly of claim 1, wherein the protector comprises:
an inner protector portion surrounding the outer surface of the domes and having a first strength; and
an outer protector portion having a second strength greater than the first strength and configured to entirely surround a surface of the inner protector portion.

10. The pressure vessel assembly of claim 9, wherein the inner protector portion has strengths that increase from an inner surface of the inner protector portion toward an outer surface of the inner protector portion.

11. The pressure vessel assembly of claim 9, wherein the outer protector portion has strengths that increase from an inner surface of the outer protector portion toward an outer surface of the outer protector portion.

12. The pressure vessel assembly of claim 9, wherein the inner protector portion and the outer protector portion are provided as a unitary one-piece structure by a single process.

13. The pressure vessel assembly of claim 1, wherein the protector comprises a curved close contact portion having a curvature, which corresponds to an outer surface of the pressure vessel, and attached to the outer surface of the pressure vessel.

14. The pressure vessel assembly of claim 5, wherein the protector comprises a flat surface portion configured to define a part of an outer surface of the protector.

15. The pressure vessel assembly of claim 14, wherein the flat surface portion is inclined at a reference angle that is predetermined with respect to a reference line in an axial direction of the pressure vessel.

16. The pressure vessel assembly of claim 15, wherein the reference angle is a value in a range of 30 degrees to 60 degrees.

17. The pressure vessel assembly of claim 14, further comprising:
a round portion provided between the stepped portion and the flat surface portion.

18. The pressure vessel assembly of claim 14, wherein the protector comprises a curved guide portion configured to guide the restraint band, which traverses the stepped portion, to the cylinder.

19. The pressure vessel assembly of claim 1, wherein a thickness of the protector increases from a first end of the protector toward a second end of the protector, and wherein the first end of the protector is adjacent to the cylinder.

20. A pressure vessel assembly comprising:
a pressure vessel, wherein two opposite ends of the pressure vessel have dome shapes;
a protector configured to surround an outer surface of the two opposite ends; and
a restraint band configured to surround the protector and the pressure vessel, restrain the protector to the pressure vessel, and define exposure regions through which the protector and the pressure vessel are partially exposed.
